(19) United States
(12) Patent Application Publication
(10) Pub. No.: US 2012/0041945 A1
(43) Pub. Date: Feb. 16, 2012

(54) MECHANISM FOR FACILITATING EFFICIENT COLLECTION AND PRESENTATION OF BUSINESS ACTIVITY MONITORING DATA

(75) Inventor: MICHAEL DAVID BLUBAUGH, San Francisco, CA (US)

(73) Assignee: SALESFORCE.COM, INC., San Francisco, CA (US)

(21) Appl. No.: 12/973,726

(22) Filed: Dec. 20, 2010

Related U.S. Application Data
(60) Provisional application No. 61/374,085, filed on Aug. 16, 2010.

(51) Int. Cl. G06F 17/30

(52) U.S. Cl. 707/722; 707/E17.009

(57) ABSTRACT

In accordance with embodiments, there are provided methods and systems for facilitating efficient collection and presentation of business activity monitoring data. A method of embodiments includes receiving business activity monitoring (BAM) data from a business process management (BPM) engine residing at a first entity. The BAM data is received in a first format that is compatible with the first entity. The method further includes customizing the first format of the BAM data into a second format of the BAM data. The second format is compatible with the second entity. The second entity includes an organization whose business activities are monitored to generate the BAM data that relates to monitoring of the business activities.

### CLAIM OF PRIORITY

This application claims the benefit of U.S. Provisional Patent Application No. 61/374,085, entitled “Business Activity Feed” by Mike Blubaugh, filed Aug. 16, 2010 (Attorney Docket No. 8956P037Z), the entire contents of which are incorporated herein by reference and priority is claimed thereof.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### TECHNICAL FIELD

One or more implementations relate generally to business activity monitoring and, more specifically, to a mechanism for facilitating efficient collection and presentation of business activity monitoring data in a database network system computing environment.

### BACKGROUND

The subject matter discussed in the background section should not be assumed to be prior art merely as a result of its mention in the background section. Similarly, a problem mentioned in the background section or associated with the subject matter of the background section should not be assumed to have been previously recognized in the prior art. The subject matter in the background section merely represents different approaches, which in and of themselves may also be inventions.

In today's business environment, various business activities (e.g., start/stop/duration time of a business project, modification to employee details, workflow tasks, etc.) are monitored by Business Process Management (BPM) engines or platforms. This monitoring process is referred to as Business Activity Monitoring (BAM). A BPM engine refers to a management entity (e.g., software, hardware, or a combination of both) to synchronize organization and client goals while promoting business effectiveness and flexibility.

However, monitoring information relating to such business activities are typically provided in log files at the source. In other words, if an interested party (e.g., a Human Resources (HR) manager, a salesperson, a computer developer, project support teams, etc.) wishes to obtain relevant monitoring information, they would have to typically rely on accessing it from log files or consoles provided by the source (e.g., a particular product) of the BPM engine itself. Since a BPM engine may be provided by a third-party organization, their log files and consoles would be limited in their data format as provided by the BPM engine and may not be friendly to or compatible with the data formats that are generally supported by the host organization (e.g., a business organization or company) whose business activities are being monitored by the BPM engine. These conventional monitoring information collection processes can be unfriendly, cumbersome, and prone to human error, and can become convoluted, inefficient, and costly when large amounts of monitoring information is to be obtained and/or a large number of interested parties are involved, and so forth.

In conventional database systems, users access their data resources in one logical database. A user of such a conventional system typically retrieves data from and stores data on the system using the user's own systems. A user system might remotely access one of a plurality of server systems that might in turn access the database system. Data retrieval from the system might include the issuance of a query from the user system to the database system. The database system might process the request for information received in the query and send to the user system information relevant to the request.

Unfortunately, conventional database approaches might process a query relatively slowly and inefficiently if, for example, the number of queries received by the database system or the number of interested parties is relatively high, or the format of the results of such queries is incompatible with the format supported by the host organization.

### SUMMARY

In accordance with embodiments, there are provided methods and systems for facilitating efficient collection and presentation of business activity monitoring data. A method of embodiments includes receiving business activity monitoring (BAM) data from a business process management (BPM) engine residing at a first entity. The BAM data is received in a first format that is compatible with the first entity. The method further includes customizing the first format of the BAM data into a second format of the BAM data. The second format is compatible with the second entity. The second entity includes an organization whose business activities are monitored to generate the BAM data that relates to monitoring of the business activities.

While one or more implementation techniques are described with reference to an embodiment in which techniques for efficient collection and presentation of business activity monitoring data in a database network system computing environment are implemented in a system having an application server providing a front end for an on-demand database service capable of supporting multiple tenants, the one or more implementations are not limited to multi-tenant databases nor deployment on application servers. Embodiments may be practiced using other database architectures, i.e., ORACLE®, DB2® by IBM and the like without departing from the scope of the embodiments claimed.

Any of the above embodiments may be used alone or together with one another in any combination. One or more implementations encompassed within this specification may also include embodiments that are only partially mentioned or alluded to or are not mentioned or alluded to at all in this brief summary or in the abstract. Although various embodiments may have been motivated by various deficiencies with the prior art, which may be discussed or alluded to in one or more places in the specification, the embodiments do not necessarily address any of these deficiencies. In other words, different embodiments may address different deficiencies that may be discussed in the specification. Some embodiments may only partially address some deficiencies or just one deficiency that may be discussed in the specification, and some embodiments may not address any of these deficiencies.

### BRIEF DESCRIPTION OF THE DRAWINGS

In the following drawings like reference numbers are used to refer to like elements. Although the following figures depict various examples, one or more implementations are not limited to the examples depicted in the figures.

FIG. 1 illustrates a host machine employing business activity monitoring mechanism according to one embodiment;

FIG. 2 illustrates business activity monitoring mechanism according to one embodiment;

FIG. 3 illustrates a method for efficient collection and presentation of business activity monitoring data according to one embodiment;

FIG. 4 illustrates a computer system according to one embodiment;

FIG. 5 illustrates a block diagram of an environment wherein an on-demand database service might be used according to one embodiment; and

FIG. 6 illustrates a block diagram of an embodiment of elements of environment of FIG. 5 and various possible interconnections between these elements according to one embodiment.

### DETAILED DESCRIPTION

Methods and systems are provided for facilitating efficient collection and presentation of business activity monitoring data.

Embodiments provide for an efficient collection and presentation of monitoring data relating to business activities of an organization. In one embodiment, monitoring data is provided, periodically or on-demand, to a user (e.g., a party of interest, such as individual employees in various positions, HR or other departments, software developers, production support teams, C-level management, etc.) in a format that is friendly to the user and compatible with the local or host organization (e.g., company or business organization, government entity, educational institute) of the user.

Monitoring of business activities by a BPM engine or platform may include tracking of individual business activities (also referred to as “processes”) to provide periodic status and relevant statistics of such processes. An example of status may include tracking status of a product shipment and its statistics may include on-time delivery rate of such product shipments, number of orders placed per month, amount billed to customers versus amount received from customers, and the like. Monitoring of business processes can help in identifying existing and/or potential problems so that performance of such processes may be improved. It is contemplated that wide range in terms of type and number of business activities or processes can be monitored depending on the goals of a business organization and their customers' needs and wants. Further, monitoring can be done, in real-time, periodically or on-demand. BPM engines or platforms are provided by various companies, such as Oracle®, Cordys, Boomi®, etc.

As used herein, the term multi-tenant database system refers to those systems in which various elements of hardware and software of the database system may be shared by one or more customers. For example, a given application server may simultaneously process requests for a great number of customers, and a given database table may store rows for a potentially much greater number of customers. As used herein, the term query plan refers to a set of steps used to access information in a database system.

Next, mechanisms and methods for providing efficient collection and presentation of business activity monitoring data will be described with reference to example embodiments.

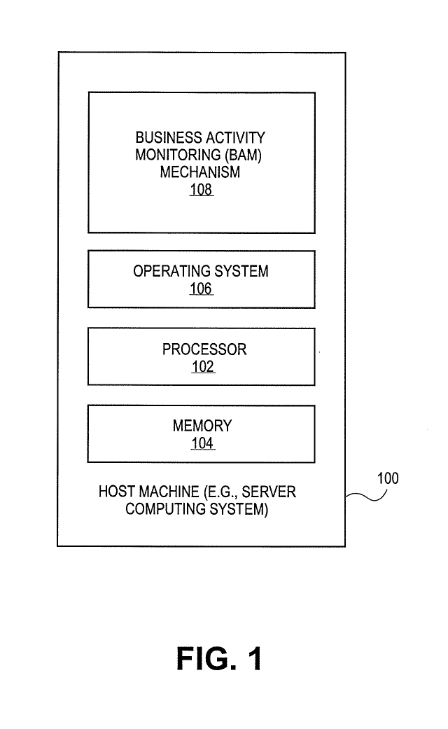

FIG. 1 illustrates a host machine 100 employing business activity monitoring mechanism 108 according to one embodiment. Host machine 100 comprises a computing platform, which may be capable, for example, of working with a standard operating system 106. Operating system 106 serves as an interface between any hardware or physical resources of the host machine 100 and a user. In some embodiments, base hardware platform may include a processor 102, memory devices 104, network devices, drivers, and so on. Host machine 100 may include a server computing system or a client computing system and further, terms like “machine”, “device”, “computer”, “computing device”, and “computing system” are used interchangeably and synonymously throughout this document.

In one embodiment, the host machine 100 employs business activity monitoring (BAM) mechanism 108 (also referred herein as “BAM feed”) to provide an efficient collection and presentation of monitoring data obtained from monitoring of business activities or processes of, for example, a business organization. In one embodiment, the BAM mechanism 108 may passively receive (via a “push” mechanism) or actively demand (e.g., a “pull” mechanism) BAM data from any number of BPM engines or platforms responsible for monitoring various activities of the organization. The BAM data is then processed by the BAM mechanism 108 using certain available information or techniques, such as configuration files 228, transformation logic 230, etc., to convert the data into a format acceptable (and/or preferred) by the host organization.

For example, a BPM engine monitors employment processes and the BAM data relating to employment process monitoring received at the BAM mechanism 108. Here, the employment BAM data is processed and transformed using configuration files 228, transformation logic 230, etc., into a form that is acceptable and/or preferred by the host organization (e.g., salesforce.com). Continuing with the example, object service (e.g., salesforce.com object service) may be used to invoke salesforce.com and handling logging and errors. Further, for example, custom objects (e.g., salesforce.com custom objects) may be used to store the employment BAM data using a particular format (e.g., a template) to ensure consistency and compatibility with the organization; consequently, using the custom objects, various reports and BAM dashboards are provided for the user to see view the employment BAM data. In one embodiment, custom objects and reports and dashboards being part of the BAM mechanism 108 may reside at the host machine 100 or at one or more cloud machines of cloud architecture in communication with remote client machines that are used by end-users to view the BAM data.

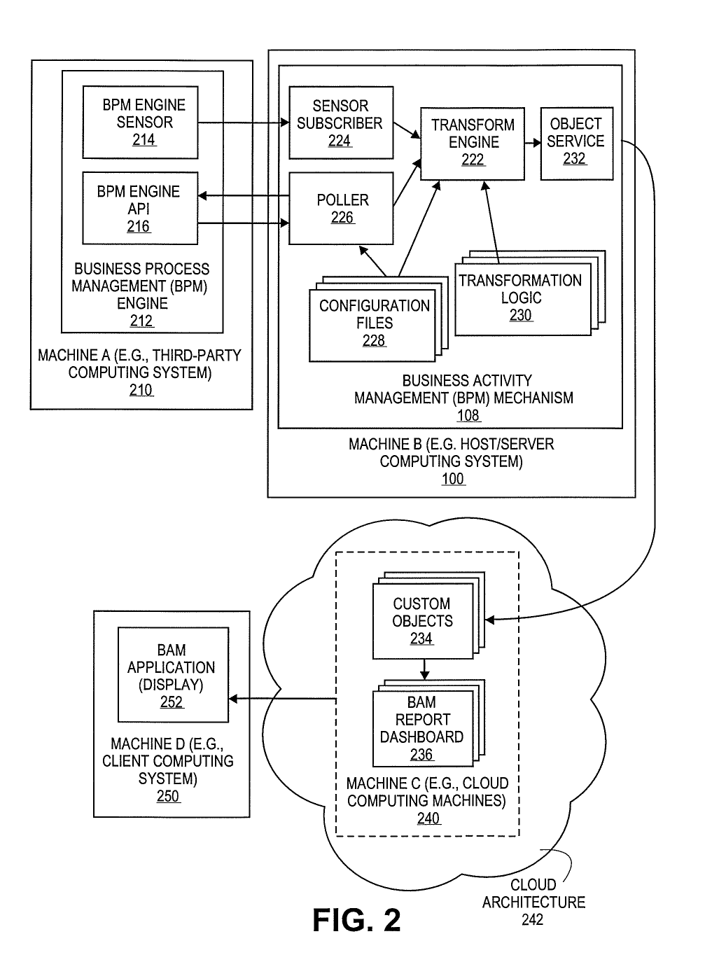

FIG. 2 illustrates business activity monitoring mechanism 108 according to one embodiment. In one embodiment, BAM mechanism 108 is hosted by machine B 100 which may include a server computing system in communication with machine A 210 that hosts a BPM engine 212, and machine C 240 which represents any number of computing systems that are part of cloud computing or architecture 242 having a large group of computing systems. In the illustrated embodiment, custom objects 234 and report and dashboards 236 are shown at the cloud architecture 242, but, as described with reference to FIG. 1, they are regarded as part of the BAM mechanism 108 that, in the illustrated case, is extended into the cloud architecture 242.

In one embodiment, the BPM engine or platform 212 (e.g., Oracle BPEL engine, Cordys, Boomi, etc.) includes one or more sensors 214 and/or one or more Application Programming Interfaces (API) 216 to communicate BAM data to the BAM mechanism. In one embodiment, a sensor 214 registers itself with the BPM engine 212 so that any BAM data produced by the BPM engine 212 can be “pushed” (according to a “push” mechanism) to a sensor subscriber 224 of the BAM mechanism 108. The sensor subscriber 224 listens to the BAM data that it periodically receives from the sensor 214 according to, for example, predetermined criteria. In another embodiment, a poller 226 of the BPM mechanism 108 polls (according to a “pull” mechanism) an API of the BPM engine 212 for the BAM data that the BPM engine 212 has collected. It is contemplated that both the push and pull mechanisms can be used simultaneously or the BAM mechanism 108 can alternate between the two or one of the push and pull mechanisms may be used exclusively, as desired or necessitated.

Once the data has been received at the BAM mechanism 108, it is then sent to a transform engine 222 for additional processing. Examples of such as transform engine 222 include, but are not limited to, Extensible Markup Language (XML) Intelligent Transform Engine (XITE), CR-X transformation engine, etc. The transform engine 222 analyzes the type of BAM data that is published by the BPM engine 212 and received at the transform engine 222 and uses a particular transformation standard (e.g., Extensible Stylesheet Language Transformations (XSLT), XML Query (XQuery), etc.) to convert or transform the received BAM data into a custom format using, for example, an object service or service call (e.g., salesforce.com web service call). In one embodiment, the transform engine 222 is capable of using various transformation standards (e.g., logic code, language formats, intelligence, etc.) provided by transformation files 230 and configuration information (e.g., configuration code to look for and understand messages relating to third-party processes, such as relating to employment updates received from a third-party BPM engine 212) provided by configuration files 228 to receive BAM data from any number or type of BPM engines 212 and transform the BAM data into any number or type of customized formats to provide the BAM data to a user (e.g., employees, project groups, software developers, company management, etc.) via a BAM application 252 that is used to receive and display the BAM data on a user device 250.

In one embodiment, the aforementioned object service 232 is responsible for invoking the proper customized format (e.g., a salesforce.com object service invokes a salesforce.com customized format) and handing the relevant logging (of BAM data-related transactions) and error transactions by generating custom objects 234 (e.g., salesforce.com custom objects). Custom objects 234 refer to data entries that are used for storing BAM data using, for example, templates to ensure consistency. Using custom objects 234, various customized and/or compatible reports and dashboards 236 (e.g., salesforce.com BAM dashboard) are generated and provided as BAM dashboard, etc., via a BAM application 252 to the user. As aforementioned, custom objects 234 and reports/dashboards 236 are generated and provided as part of the BAM mechanism 208; although, they may be accessed and provided through cloud machines C 240 that are part of a cloud computing architecture 242. In one embodiment, a Graphical User Interface (GUI)-based BAM application 252 may be used at the client machine D 250 to provide BAM dashboard or other form of BAM data display to the user. Similarly, the BAM application 252 can be used to provide log or error details generated by the BAM mechanism 108 to the user.

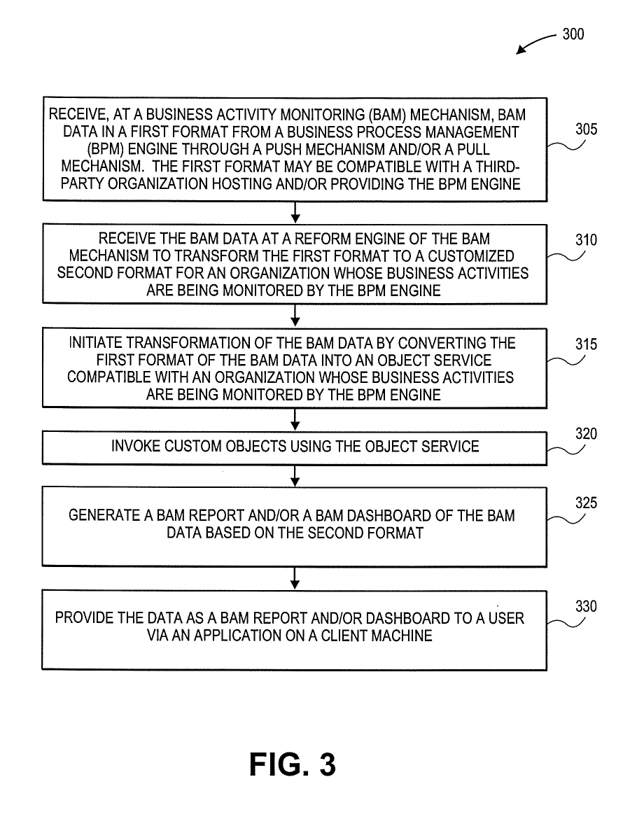

FIG. 3 illustrates a method for facilitating efficient collection and presentation of business activity monitoring data according to one embodiment. Method 300 may be performed by hardware, software, or a combination thereof. In one embodiment, method 300 is performed by business activity monitoring mechanism of FIG. 1.

Method 300 begins within BAM mechanism receiving BAM data in a first format from a BPM engine at block 305. This first format is acceptable to, compatible with, and provided by a third-party organization or computing system hosting the BPM engine. In one embodiment, the BAM data is provided based on the push mechanism from a sensor at the BPM engine to a sensor subscriber of the BAM mechanism. In another embodiment, the BAM data is provided based on the pull mechanism from an API at the BPM engine to a poller of the BAM mechanism. At block 310, the BAM data is received by a transform engine 222 of the BAM mechanism to be processed from the first format to a second format. The second format is acceptable to and compatible with a receiving entity, such as the organization or company (e.g., salesforce.com) whose business activities are being monitored by the BPM engine and whose users (e.g., employees, management, project teams, etc.) are expected to review and process the BAM data. The transform engine, in one embodiment, uses configuration files 228 (e.g., configuration code) and transformation logic (e.g., transformation standards, such as XSLT, etc.) to convert the first format into an object service (e.g., web service call, such as a salesforce.com web service call) for the first format to be eventually converted in the second format at block 315.

At block 320, the object service invokes custom objects (e.g., salesforce.com custom objects) of the business organization or company for storing the BAM data at a local database using an acceptable system, such as customized or standard templates to ensure consistency. Other than invoking custom objects, the object service may be used to form and provide logging and error tracking information relating to BAM data-related transactions. At block 325, using the invoked custom objects, various customized reports and BAM dashboards (e.g., salesforce.com BAM dashboard) are generated in the second format. At block 330, such BAM reports and dashboards in the second format are provided to the user via a BAM application on a client machine.

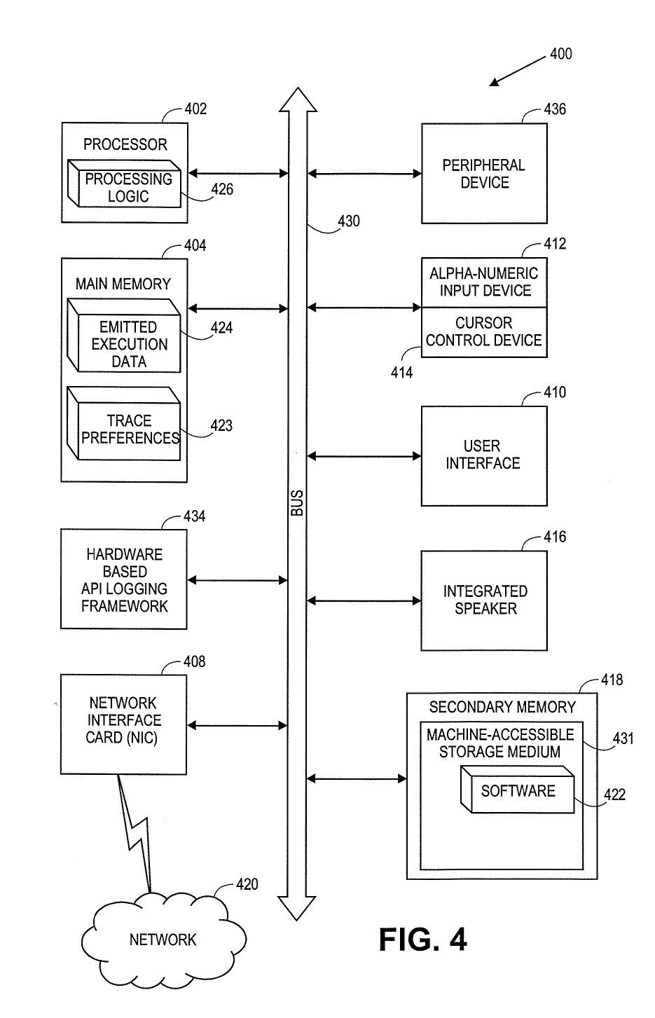

FIG. 4 illustrates a diagrammatic representation of a machine 400 in the exemplary form of a computer system, in accordance with one embodiment, within which a set of instructions, for causing the machine 400 to perform any one or more of the methodologies discussed herein, may be executed. In alternative embodiments, the machine may be connected (e.g., networked) to other machines in a Local Area Network (LAN), an intranet, an extranet, or the Internet. The machine may operate in the capacity of a server or a client machine in a client-server network environment, or as a peer machine in a peer-to-peer (or distributed) network environment or as a server or series of servers within an on-demand service environment, including an on-demand environment providing multi-tenant database storage services. Certain embodiments of the machine may be in the form of a personal computer (PC), a tablet PC, a set-top box (STB), a Personal Digital Assistant (PDA), a cellular telephone, a web appliance, a server, a network router, switch or bridge, computing system, or any machine capable of executing a set of instructions (sequential or otherwise) that specify actions to be taken by that machine. Further, while only a single machine is illustrated, the term “machine” shall also be taken to include any collection of machines (e.g., computers) that individually or jointly execute a set (or multiple sets) of instructions to perform any one or more of the methodologies discussed herein.

The exemplary computer system 400 includes a processor 402, a main memory 404 (e.g., read-only memory (ROM), flash memory, dynamic random access memory (DRAM) such as synchronous DRAM (SDRAM) or Rambus DRAM (RDRAM), etc., static memory such as flash memory, static random access memory (SRAM), volatile but high-data rate RAM, etc.), and a secondary memory 418 (e.g., a persistent storage device including hard disk drives and persistent multi-tenant data base implementations), which communicate with each other via a bus 430. Main memory 404 includes emitted execution data 424 (e.g., data emitted by a logging framework) and one or more trace preferences 423 which operate in conjunction with processing logic 426 and processor 402 to perform the methodologies discussed herein.

Processor 402 represents one or more general-purpose processing devices such as a microprocessor, central processing unit, or the like. More particularly, the processor 402 may be a complex instruction set computing (CISC) microprocessor, reduced instruction set computing (RISC) microprocessor, very long instruction word (VLIW) microprocessor, processor implementing other instruction sets, or processors implementing a combination of instruction sets. Processor 402 may also be one or more special-purpose processing devices such as an application specific integrated circuit (ASIC), a field programmable gate array (FPGA), a digital signal processor (DSP), network processor, or the like. Processor 402 is configured to execute the processing logic 426 for performing the operations and functionality of BAM mechanism 108 as described with reference to FIG. 1 and other figures discussed herein.

The computer system 400 may further include a network interface card 408. The computer system 400 also may include a user interface 410 (such as a video display unit, a liquid crystal display (LCD), or a cathode ray tube (CRT)), an alphanumeric input device 412 (e.g., a keyboard), a cursor control device 414 (e.g., a mouse), and a signal generation device 416 (e.g., an integrated speaker). The computer system 400 may further include peripheral device 436 (e.g., wireless or wired communication devices, memory devices, storage devices, audio processing devices, video processing devices, etc. The computer system 400 may further include a Hardware based API logging framework 434 capable of executing incoming requests for services and emitting execution data responsive to the fulfillment of such incoming requests.

The secondary memory 418 may include a non-transitory machine-readable storage medium (or more specifically a machine-accessible storage medium) 431 on which is stored one or more sets of instructions (e.g., software 422) embodying any one or more of the methodologies or functions of BAM mechanism 108 as described with reference to FIG. 1 and other figures described herein. The software 422 may also reside, completely or at least partially, within the main memory 404 and/or within the processor 402 during execution thereof by the computer system 400, the main memory 404 and the processor 402 also constituting machine-readable storage media. The software 422 may further be transmitted or received over a network 420 via the network interface card 408.

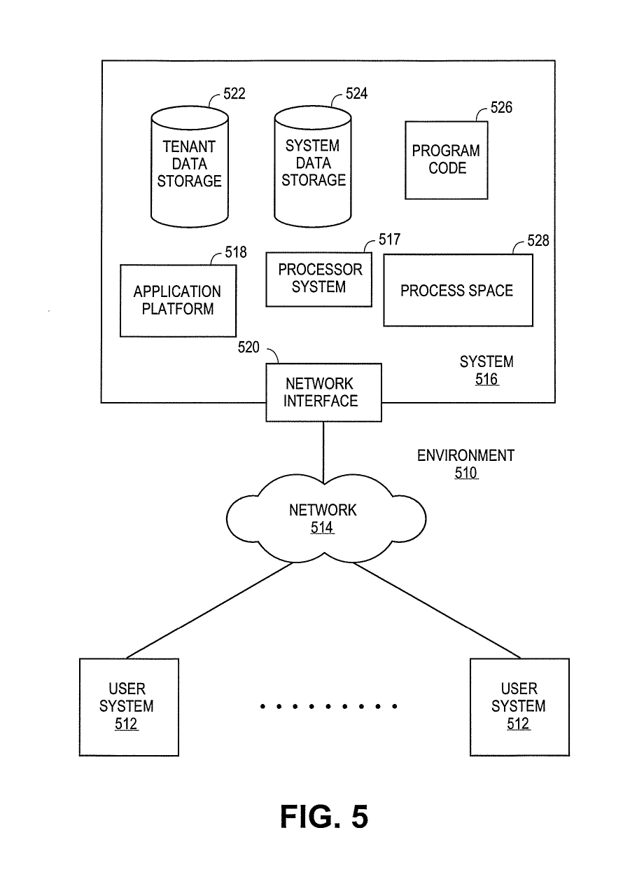

FIG. 5 illustrates a block diagram of an environment 510 wherein an on-demand database service might be used. Environment 510 may include user systems 512, network 514, system 516, processor system 517, application platform 518, network interface 520, tenant data storage 522, system data storage 524, program code 526, and process space 528. In other embodiments, environment 510 may not have all of the components listed and/or may have other elements instead of, or in addition to, those listed above.

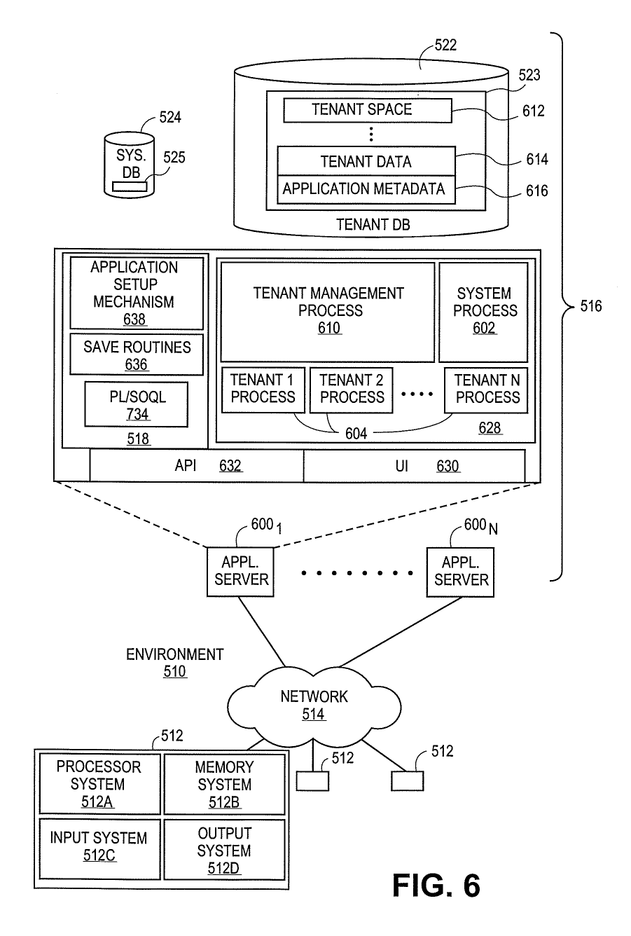

Environment 510 is an environment in which an on-demand database service exists. User system 512 may be any machine or system that is used by a user to access a database user system. For example, any of user systems 512 can be a handheld computing device, a mobile phone, a laptop computer, a work station, and/or a network of computing devices. As illustrated in herein FIG. 5 (and in more detail in FIG. 6) user systems 512 might interact via a network 514 with an on-demand database service, which is system 516.

An on-demand database service, such as system 516, is a database system that is made available to outside users that do not need to necessarily be concerned with building and/or maintaining the database system, but instead may be available for their use when the users need the database system (e.g., on the demand of the users). Some on-demand database services may store information from one or more tenants stored into tables of a common database image to form a multi-tenant database system (MTS). Accordingly, “on-demand database service 516” and “system 516” will be used interchangeably herein. A database image may include one or more database objects. A relational database management system (RDMS) or the equivalent may execute storage and retrieval of information against the database object(s). Application platform 518 may be a framework that allows the applications of system 516 to run, such as the hardware and/or software, e.g., the operating system. In an embodiment, on-demand database service 516 may include an application platform 518 that enables creation, managing and executing one or more applications developed by the provider of the on-demand database service, users accessing the on-demand database service via user systems 512, or third party application developers accessing the on-demand database service via user systems 512.

The users of user systems 512 may differ in their respective capacities, and the capacity of a particular user system 512 might be entirely determined by permissions (permission levels) for the current user. For example, where a salesperson is using a particular user system 512 to interact with system 516, that user system has the capacities allotted to that salesperson. However, while an administrator is using that user system to interact with system 516, that user system has the capacities allotted to that administrator. In systems with a hierarchical role model, users at one permission level may have access to applications, data, and database information accessible by a lower permission level user, but may not have access to certain applications, database information, and data accessible by a user at a higher permission level. Thus, different users will have different capabilities with regard to accessing and modifying application and database information, depending on a user's security or permission level.

Network 514 is any network or combination of networks of devices that communicate with one another. For example, network 514 can be any one or any combination of a LAN (local area network), WAN (wide area network), telephone network, wireless network, point-to-point network, star network, token ring network, hub network, or other appropriate configuration. As the most common type of computer network in current use is a TCP/IP (Transfer Control Protocol and Internet Protocol) network, such as the global internetwork of networks often referred to as the “Internet” with a capital “I,” that network will be used in many of the examples herein. However, it should be understood that the networks that one or more implementations might use are not so limited, although TCP/IP is a frequently implemented protocol.

User systems 512 might communicate with system 516 using TCP/IP and, at a higher network level, use other common Internet protocols to communicate, such as HTTP, FTP, AFS, WAP, etc. In an example where HTTP is used, user system 512 might include an HTTP client commonly referred to as a “browser” for sending and receiving HTTP messages to and from an HTTP server at system 516. Such an HTTP server might be implemented as the sole network interface between system 516 and network 514, but other techniques might be used as well or instead. In some implementations, the interface between system 516 and network 514 includes load sharing functionality, such as round-robin HTTP request distributors to balance loads and distribute incoming HTTP requests evenly over a plurality of servers. At least as for the users that are accessing that server, each of the plurality of servers has access to the MTS' data; however, other alternative configurations may be used instead.

In one embodiment, system 516, shown in FIG. 5, implements a web-based customer relationship management (CRM) system. For example, in one embodiment, system 516 includes application servers configured to implement and execute CRM software applications as well as provide related data, code, forms, webpages and other information to and from user systems 512 and to store to, and retrieve from, a database system related data, objects, and Webpage content. With a multi-tenant system, data for multiple tenants may be stored in the same physical database object, however, tenant data typically is arranged so that data of one tenant is kept logically separate from that of other tenants so that one tenant does not have access to another tenant's data, unless such data is expressly shared. In certain embodiments, system 516 implements applications other than, or in addition to, a CRM application. For example, system 516 may provide tenant access to multiple hosted (standard and custom) applications, including a CRM application. User (or third party developer) applications, which may or may not include CRM, may be supported by the application platform 518, which manages creation, storage of the applications into one or more database objects and executing of the applications in a virtual machine in the process space of the system 516.

One arrangement for elements of system 516 is shown in FIG. 5, including a network interface 520, application platform 518, tenant data storage 522 for tenant data 523, system data storage 524 for system data 525 accessible to system 516 and possibly multiple tenants, program code 526 for implementing various functions of system 516, and a process space 528 for executing MTS system processes and tenant-specific processes, such as running applications as part of an application hosting service. Additional processes that may execute on system 516 include database indexing processes.

Several elements in the system shown in FIG. 5 include conventional, well-known elements that are explained only briefly here. For example, each user system 512 could include a desktop personal computer, workstation, laptop, PDA, cell phone, or any wireless access protocol (WAP) enabled device or any other computing device capable of interfacing directly or indirectly to the Internet or other network connection. User system 512 typically runs an HTTP client, e.g., a browsing program, such as Microsoft's Internet Explorer browser, Netscape's Navigator browser, Opera's browser, or a WAP-enabled browser in the case of a cell phone, PDA or other wireless device, or the like, allowing a user (e.g., subscriber of the multi-tenant database system) of user system 512 to access, process and view information, pages and applications available to it from system 516 over network 514. Each user system 512 also typically includes one or more user interface devices, such as a keyboard, a mouse, trackball, touch pad, touch screen, pen or the like, for interacting with a graphical user interface (GUI) provided by the browser on a display (e.g., a monitor screen, LCD display, etc.) in conjunction with pages, forms, applications and other information provided by system 516 or other systems or servers. For example, the user interface device can be used to access data and applications hosted by system 516, and to perform searches on stored data, and otherwise allow a user to interact with various GUI pages that may be presented to a user. As discussed above, embodiments are suitable for use with the Internet, which refers to a specific global internetwork of networks. However, it should be understood that other networks can be used instead of the Internet, such as an intranet, an extranet, a virtual private network (VPN), a non-TCP/IP based network, any LAN or WAN or the like.

According to one embodiment, each user system 512 and all of its components are operator configurable using applications, such as a browser, including computer code run using a central processing unit such as an Intel Pentium® processor or the like. Similarly, system 516 (and additional instances of an MTS, where more than one is present) and all of their components might be operator configurable using application(s) including computer code to run using a central processing unit such as processor system 517, which may include an Intel Pentium® processor or the like, and/or multiple processor units. A computer program product embodiment includes a machine-readable storage medium (media) having instructions stored thereon/in which can be used to program a computer to perform any of the processes of the embodiments described herein. Computer code for operating and configuring system 516 to intercommunicate and to process webpages, applications and other data and media content as described herein are preferably downloaded and stored on a hard disk, but the entire program code, or portions thereof, may also be stored in any other volatile or non-volatile memory medium or device as is well known, such as a ROM or RAM, or provided on any media capable of storing program code, such as any type of rotating media including floppy disks, optical discs, digital versatile disk (DVD), compact disk (CD), microdrive, and magneto-optical disks, and magnetic or optical cards, nanosystems (including molecular memory ICs), or any type of media or device suitable for storing instructions and/or data. Additionally, the entire program code, or portions thereof, may be transmitted and downloaded from a software source over a transmission medium, e.g., over the Internet, or from another server, as is well known, or transmitted over any other conventional network connection as is well known (e.g., extranet, VPN, LAN, etc.) using any communication medium and protocols (e.g., TCP/IP, HTTP, HTTPS, Ethernet, etc.) as are well known. It will also be appreciated that computer code for implementing embodiments can be implemented in any programming language that can be executed on a client system and/or server or server system such as, for example, C, C++, HTML, any other markup language, Java™, JavaScript, ActiveX, any other scripting language, such as VBScript, and many other programming languages as are well known may be used. (Java™ is a trademark of Sun Microsystems, Inc.).

According to one embodiment, each system 516 is configured to provide webpages, forms, applications, data and media content to user (client) systems 512 to support the access by user systems 512 as tenants of system 516. As such, system 516 provides security mechanisms to keep each tenant's data separate unless the data is shared. If more than one MTS is used, they may be located in close proximity to one another (e.g., in a server farm located in a single building or campus), or they may be distributed at locations remote from one another (e.g., one or more servers located in city A and one or more servers located in city B). As used herein, each MTS could include one or more logically and/or physically connected servers distributed locally or across one or more geographic locations. Additionally, the term “server” is meant to include a computer system, including processing hardware and process space(s), and an associated storage system and database application (e.g., OODBMS or RDBMS) as is well known in the art. It should also be understood that “server system” and “server” are often used interchangeably herein. Similarly, the database object described herein can be implemented as single databases, a distributed database, a collection of distributed databases, a database with redundant online or offline backups or other redundancies, etc., and might include a distributed database or storage network and associated processing intelligence.

FIG. 6 also illustrates environment 510. However, in FIG. 6 elements of system 516 and various interconnections in an embodiment are further illustrated. FIG. 6 shows that user system 512 may include processor system 512A, memory system 512B, input system 512C, and output system 512D. FIG. 6 shows network 514 and system 516. FIG. 6 also shows that system 516 may include tenant data storage 522, tenant data 523, system data storage 524, system data 525, User Interface (UI) 630, Application Program Interface (API) 632, PL/SOQL 634, save routines 636, application setup mechanism 638, applications servers 600₁-600_{N}, system process space 602, tenant process spaces 604, tenant management process space 610, tenant storage area 612, user storage 614, and application metadata 616. In other embodiments, environment 510 may not have the same elements as those listed above and/or may have other elements instead of, or in addition to, those listed above.

User system 512, network 514, system 516, tenant data storage 522, and system data storage 524 were discussed above in FIG. 5. Regarding user system 512, processor system 512A may be any combination of one or more processors. Memory system 512B may be any combination of one or more memory devices, short term, and/or long term memory. Input system 512C may be any combination of input devices, such as one or more keyboards, mice, trackballs, scanners, cameras, and/or interfaces to networks. Output system 512D may be any combination of output devices, such as one or more monitors, printers, and/or interfaces to networks. As shown by FIG. 6, system 516 may include a network interface 520 (of FIG. 5) implemented as a set of HTTP application servers 600, an application platform 518, tenant data storage 522, and system data storage 524. Also shown is system process space 602, including individual tenant process spaces 604 and a tenant management process space 610. Each application server 600 may be configured to tenant data storage 522 and the tenant data 523 therein, and system data storage 524 and the system data 525 therein to serve requests of user systems 512. The tenant data 523 might be divided into individual tenant storage areas 612, which can be either a physical arrangement and/or a logical arrangement of data. Within each tenant storage area 612, user storage 614 and application metadata 616 might be similarly allocated for each user. For example, a copy of a user's most recently used (MRU) items might be stored to user storage 614. Similarly, a copy of MRU items for an entire organization that is a tenant might be stored to tenant storage area 612. A UI 630 provides a user interface and an API 632 provides an application programmer interface to system 516 resident processes to users and/or developers at user systems 512. The tenant data and the system data may be stored in various databases, such as one or more Oracle™ databases.

Application platform 518 includes an application setup mechanism 638 that supports application developers' creation and management of applications, which may be saved as metadata into tenant data storage 522 by save routines 636 for execution by subscribers as one or more tenant process spaces 604 managed by tenant management process 610 for example. Invocations to such applications may be coded using PL/SOQL 634 that provides a programming language style interface extension to API 632. A detailed description of some PL/SOQL language embodiments is discussed in commonly owned U.S. Pat. No. 7,730,478 entitled, “Method and System for Allowing Access to Developed Applicants via a Multi-Tenant Database On-Demand Database Service”, issued Jun. 1, 2010 to Craig Weissman, which is incorporated in its entirety herein for all purposes. Invocations to applications may be detected by one or more system processes, which manage retrieving application metadata 616 for the subscriber making the invocation and executing the metadata as an application in a virtual machine.

Each application server 600 may be communicably coupled to database systems, e.g., having access to system data 525 and tenant data 523, via a different network connection. For example, one application server 600₁ might be coupled via the network 514 (e.g., the Internet), another application server 600_{N-1} might be coupled via a direct network link, and another application server 600_{N} might be coupled by yet a different network connection. Transfer Control Protocol and Internet Protocol (TCP/IP) are typical protocols for communicating between application servers 600 and the database system. However, it will be apparent to one skilled in the art that other transport protocols may be used to optimize the system depending on the network interconnect used.

In certain embodiments, each application server 600 is configured to handle requests for any user associated with any organization that is a tenant. Because it is desirable to be able to add and remove application servers from the server pool at any time for any reason, there is preferably no server affinity for a user and/or organization to a specific application server 600. In one embodiment, therefore, an interface system implementing a load balancing function (e.g., an F5 Big-IP load balancer) is communicably coupled between the application servers 600 and the user systems 512 to distribute requests to the application servers 600. In one embodiment, the load balancer uses a least connections algorithm to route user requests to the application servers 600. Other examples of load balancing algorithms, such as round robin and observed response time, also can be used. For example, in certain embodiments, three consecutive requests from the same user could hit three different application servers 600, and three requests from different users could hit the same application server 600. In this manner, system 516 is multi-tenant, wherein system 516 handles storage of, and access to, different objects, data and applications across disparate users and organizations.

As an example of storage, one tenant might be a company that employs a sales force where each salesperson uses system 516 to manage their sales process. Thus, a user might maintain contact data, leads data, customer follow-up data, performance data, goals and progress data, etc., all applicable to that user's personal sales process (e.g., in tenant data storage 522). In an example of a MTS arrangement, since all of the data and the applications to access, view, modify, report, transmit, calculate, etc., can be maintained and accessed by a user system having nothing more than network access, the user can manage his or her sales efforts and cycles from any of many different user systems. For example, if a salesperson is visiting a customer and the customer has Internet access in their lobby, the salesperson can obtain critical updates as to that customer while waiting for the customer to arrive in the lobby.

While each user's data might be separate from other users' data regardless of the employers of each user, some data might be organization-wide data shared or accessible by a plurality of users or all of the users for a given organization that is a tenant. Thus, there might be some data structures managed by system 516 that are allocated at the tenant level while other data structures might be managed at the user level. Because an MTS might support multiple tenants including possible competitors, the MTS should have security protocols that keep data, applications, and application use separate. Also, because many tenants may opt for access to an MTS rather than maintain their own system, redundancy, up-time, and backup are additional functions that may be implemented in the MTS. In addition to user-specific data and tenant specific data, system 516 might also maintain system level data usable by multiple tenants or other data. Such system level data might include industry reports, news, postings, and the like that are sharable among tenants.

In certain embodiments, user systems 512 (which may be client systems) communicate with application servers 600 to request and update system-level and tenant-level data from system 516 that may require sending one or more queries to tenant data storage 522 and/or system data storage 524. System 516 (e.g., an application server 600 in system 516) automatically generates one or more SQL statements (e.g., one or more SQL queries) that are designed to access the desired information. System data storage 524 may generate query plans to access the requested data from the database.

Each database can generally be viewed as a collection of objects, such as a set of logical tables, containing data fitted into predefined categories. A “table” is one representation of a data object, and may be used herein to simplify the conceptual description of objects and custom objects. It should be understood that “table” and “object” may be used interchangeably herein. Each table generally contains one or more data categories logically arranged as columns or fields in a viewable schema. Each row or record of a table contains an instance of data for each category defined by the fields. For example, a CRM database may include a table that describes a customer with fields for basic contact information such as name, address, phone number, fax number, etc. Another table might describe a purchase order, including fields for information such as customer, product, sale price, date, etc. In some multi-tenant database systems, standard entity tables might be provided for use by all tenants. For CRM database applications, such standard entities might include tables for Account, Contact, Lead, and Opportunity data, each containing pre-defined fields. It should be understood that the word “entity” may also be used interchangeably herein with “object” and “table”.

In some multi-tenant database systems, tenants may be allowed to create and store custom objects, or they may be allowed to customize standard entities or objects, for example by creating custom fields for standard objects, including custom index fields. U.S. patent application Ser. No. 10/817,161, filed Apr. 2, 2004, entitled “Custom Entities and Fields in a Multi-Tenant Database System”, and which is hereby incorporated herein by reference, teaches systems and methods for creating custom objects as well as customizing standard objects in a multi-tenant database system. In certain embodiments, for example, all custom entity data rows are stored in a single multi-tenant physical table, which may contain multiple logical tables per organization. It is transparent to customers that their multiple “tables” are in fact stored in one large table or that their data may be stored in the same table as the data of other customers.

While one or more implementations have been described by way of example and in terms of the specific embodiments, it is to be understood that one or more implementations are not limited to the disclosed embodiments. To the contrary, it is intended to cover various modifications and similar arrangements as would be apparent to those skilled in the art. Therefore, the scope of the appended claims should be accorded the broadest interpretation so as to encompass all such modifications and similar arrangements. It is to be understood that the above description is intended to be illustrative, and not restrictive.

What is claimed is:

1. A computer-implemented method comprising:
receiving business activity monitoring (BAM) data from a business process management (BPM) engine residing at a first entity, wherein the BAM data is received in a first format that is compatible with the first entity; and
customizing the first format of the BAM data into a second format of the BAM data, wherein the second format is compatible with the second entity, wherein the second entity includes an organization whose business activities are monitored to generate the BAM data that relates to monitoring of the business activities.

2. The computer-implemented method of claim 1, further comprising actively receiving the BAM data by demanding the BAM data from the BPM engine.

3. The computer-implemented method of claim 1, further comprising passively receiving the BAM data, wherein passively receiving includes automatically and periodically receiving the BAM data based on predetermined criteria.

4. The computer-implemented method of claim 1, wherein the first entity comprises a provider computing system hosting the BPM engine.

5. The computer-implemented method of claim 1, wherein the second format comprising a BAM dashboard providing the BAM data.

6. The computer-implemented method of claim 1, further comprising providing the BAM dashboard to a remote computing system via cloud computing, wherein the remote computing system includes a client computing system having an application to display the BAM dashboard.

7. The computer-implemented method of claim 1, wherein receiving and customizing are performed at a third entity, the third entity including a server computing system.

8. A machine-readable medium carrying one or more sequences of instructions, which instructions, when executed by one or more processors, cause the one or more processors to carry out the steps of:
receiving business activity monitoring (BAM) data from a business process management (BPM) engine residing at a first entity, wherein the BAM data is received in a first format that is compatible with the first entity; and
customizing the first format of the BAM data into a second format of the BAM data, wherein the second format is compatible with the second entity, wherein the second entity includes an organization whose business activities are monitored to generate the BAM data that relates to monitoring of the business activities.

9. The machine-readable medium of claim 8, wherein the one or more processors are further to carry out the step of actively receiving the BAM data by demanding the BAM data from the BPM engine.

10. The machine-readable medium of claim 8, wherein the one or more processors are further to carry out the step of passively receiving the BAM data, wherein passively receiving includes automatically and periodically receiving the BAM data based on predetermined criteria.

11. The machine-readable medium of claim 8, wherein the first entity comprises a provider computing system hosting the BPM engine.

12. The machine-readable medium of claim 8, wherein the second format comprising a BAM dashboard providing the BAM data.

13. The machine-readable medium of claim 8, wherein the one or more processors are further to carry out the step of providing the BAM dashboard to a remote computing system via cloud computing, wherein the remote computing system includes a client computing system having an application to display the BAM dashboard.

14. The machine-readable medium of claim 8, wherein receiving and customizing are performed at a third entity, the third entity including a server computing system.

15. An apparatus comprising:
a processor; and
one or more stored sequences of instructions which, when executed by the processor, cause the processor to carry out the steps of:
receiving business activity monitoring (BAM) data from a business process management (BPM) engine residing at a first entity, wherein the BAM data is received in a first format that is compatible with the first entity; and
customizing the first format of the BAM data into a second format of the BAM data, wherein the second format is compatible with the second entity, wherein the second entity includes an organization whose business activities are monitored to generate the BAM data that relates to monitoring of the business activities.

16. The apparatus of claim 15, wherein the processor is further to carry out the step of: actively receiving the BAM data by demanding the BAM data from the BPM engine

17. The apparatus of claim 15, wherein the processor is further to carry out the step of: passively receiving the BAM data, wherein passively receiving includes automatically and periodically receiving the BAM data based on predetermined criteria.

18. The apparatus of claim 15, wherein the first entity comprises a provider computing system hosting the BPM engine.

19. The apparatus of claim 15, wherein the second format comprising a BAM dashboard providing the BAM data.

20. The apparatus of claim 15, wherein the processor is further to carry out the step of: providing the BAM dashboard to a remote computing system via cloud computing, wherein the remote computing system includes a client computing system having an application to display the BAM dashboard.
